(19) United States
(12) Patent Application Publication
(10) Pub. No.: US 2016/0080984 A1
(43) Pub. Date: Mar. 17, 2016

(54) PRE-EMPTIVE OVERHEAD MESSAGE READING

(71) Applicant: QUALCOMM Incorporated, San Diego, CA (US)

(72) Inventors: Chintan Pravin Turakhia, San Diego, CA (US); Srinivasan Balasubramanian, San Diego, CA (US); Vidyadhar Adiraju, San Diego, CA (US); Amir Aminzadeh Gohari, Sunnyvale, CA (US); Neelakanta Venkata Seshachalam Chimmapudi, San Diego, CA (US); Aziz Gholmieh, Del Mar, CA (US)

(21) Appl. No.: 14/850,065

(22) Filed: Sep. 10, 2015

Related U.S. Application Data
(60) Provisional application No. 62/049,272, filed on Sep. 11, 2014.

(51) Int. Cl. H04W 36/00; H04W 36/22; H04W 76/02; H04L 12/801

(52) U.S. Cl. CPC H04W 36/0061; H04L 47/12; H04W 36/22; H04W 76/02; H04W 88/02

(57) ABSTRACT

Methods, systems, and devices are described for wireless communication at a UE. A user equipment (UE) may establish a connection to a serving cell and monitor channel conditions for the serving cell and neighboring cells. Based on the channel conditions, the UE may determine to read the system information of a non-serving neighbor. The UE may then read the system information of the non-serving neighbor cell while still connected to the serving cell. In some cases, the UE may store the system information in a database. When the time comes for the UE to access the neighbor cell (e.g., if the link to the serving cell fails) the UE may proceed with access procedures without delay using the stored system information.

### CROSS REFERENCES

The present application for patent claims priority to U.S. Provisional Patent Application No. 62/049,272 by Turakhia et al., entitled “Pre-Emptive Overhead Message Reading,” filed Sep. 11, 2014, assigned to the assignee hereof, and expressly incorporated by reference herein.

### BACKGROUND

1. Field of Disclosure

The following relates generally to wireless communication, and more specifically to trigger-based pre-emptive overhead message reading.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system).

By way of example, a wireless multiple-access communications system may include a number of base stations, each simultaneously supporting communication for multiple communication devices, which may be otherwise known as a user equipment (UE). A base station may communicate with UEs on downlink channels (e.g., for transmissions from a base station to a UE) and uplink channels (e.g., for transmissions from a UE to a base station).

In some cases, such as when a UE experiences a radio link failure (RLF), the UE may attempt to read the system information of a neighboring base station in order to establish a new connection. Reading the system information may introduce a delay that may contribute to a service disruption for the user. This may occur more often in dense networks such as networks located in urban environments where cells are closely packed and channel interference is high.

### SUMMARY

Systems, methods, and apparatuses for trigger-based pre-emptive overhead message reading are described. A user equipment (UE) may establish a connection to a serving cell and monitor channel conditions or performance metrics for the serving cell and neighboring cells. Based on the channel conditions or performance metrics, the UE may determine to read the system information of a non-serving neighbor. The UE may then read the system information of the non-serving neighbor cell while still connected to the serving cell. In some cases, the UE may store the system information in a database. When the time comes for the UE to access the neighbor cell (e.g., if the link to the serving cell fails) the UE may proceed with access procedures without delay using the stored system information.

A method of wireless communication at a UE is described. The method may include establishing a connection to a serving cell, determining to read system information of a non-serving neighbor cell based at least in part on a channel condition or a performance metric, and reading the system information of the non-serving neighbor cell while connected to the serving cell.

An apparatus for wireless communication at a UE is described. The apparatus may include means for establishing a connection to a serving cell, means for determining to read system information of a non-serving neighbor cell based at least in part on a channel condition or a performance metric, and means for reading the system information of the non-serving neighbor cell while connected to the serving cell.

A further apparatus for wireless communication at a UE is described. The apparatus may include a processor, memory in electronic communication with the processor, and instructions stored in the memory, wherein the instructions are executable by the processor to establish a connection to a serving cell, determine to read system information of a non-serving neighbor cell based at least in part on a channel condition or a performance metric, and read the system information of the non-serving neighbor cell while connected to the serving cell.

A non-transitory computer-readable medium storing code for wireless communication at a UE is described. The code may include instructions executable to establish a connection to a serving cell, determine to read system information of a non-serving neighbor cell based at least in part on a channel condition or a performance metric, and read the system information of the non-serving neighbor cell while connected to the serving cell.

Some examples of the method, apparatuses, and/or non-transitory computer-readable medium described above may further include features of, means for, and/or instructions for initiating an access procedure for the non-serving neighbor cell based at least in part on the system information. Additionally or alternatively, some examples may include features of, means for, and/or instructions for storing the system information in a database for a set of neighbor cells.

In some examples of the method, apparatuses, and/or non-transitory computer-readable medium described above, the database comprises frequency information, a public land mobile network (PLMN), a cell identification (ID), information from a master information block (MIB), information from a system information block (SIB), signal quality information, measurement report information, or accessibility information. Additionally or alternatively, some examples may include prioritizing the set of neighbor cells based at least in part on the database.

Some examples of the method, apparatuses, and/or non-transitory computer-readable medium described above may further include features of, means for, and/or instructions for associating at least one entry in the database with a time limit, wherein the at least one entry is based on the system information, determining that the at least one entry is not current based on the time limit, and rereading the system information based on the determination that the at least one entry is not current while connected to the serving cell. Additionally or alternatively, some examples may include features of, means for, and/or instructions for selecting the non-serving neighbor cell based on a received signal quality of the non-serving neighbor cell, wherein reading the system information is based on the selection.

Some examples of the method, apparatuses, and/or non-transitory computer-readable medium described above include identifying the channel condition or a performance metric. In some cases, identifying the channel condition or performance metric comprises determining that a reference signal received power (RSRP) of the serving cell is below an RSRP threshold, determining that a reference signal received quality (RSRQ) of the serving cell is below an RSRQ threshold, determining that a difference between the RSRQ of the serving cell and an RSRQ of the non-serving neighbor cell exceeds a difference threshold, determining that an application layer packet loss value exceeds an application layer packet loss threshold, determining that a voice packet loss value exceeds a voice packet loss threshold, or determining that a block error rate (BLER) exceeds a BLER threshold. Additionally or alternatively, some examples may include features of, means for, and/or instructions for initiating a radio link failure (RLF) procedure on the serving cell based on the channel condition, and establishing a connection to the non-serving neighbor cell based on the system information and the RLF procedure.

In some examples of the method, apparatuses, and/or non-transitory computer-readable medium described above, reading the system information comprises receiving the system information over a secondary antenna. Additionally or alternatively, in some examples the system information comprises a MIB, one or more SIBS, or both.

In some examples of the method, apparatuses, and/or non-transitory computer-readable medium described above, the channel condition is based at least in part on a measurement gap. Additionally or alternatively, in some examples the channel condition is based at least in part on a motion detection value.

In some examples of the method, apparatuses, and/or non-transitory computer-readable medium described above, the channel condition is based at least in part on a quality of service (QoS) threshold.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system for trigger-based pre-emptive overhead message reading in accordance with various aspects of the present disclosure;

FIG. 2 illustrates an example of a wireless communications subsystem for trigger-based pre-emptive overhead message reading in accordance with various aspects of the present disclosure;

FIG. 3 illustrates an example of a channel condition diagram for trigger-based pre-emptive overhead message reading in accordance with various aspects of the present disclosure;

FIG. 4 illustrates an example of a signal flow diagram for trigger-based pre-emptive overhead message reading in accordance with various aspects of the present disclosure;

FIG. 5 shows a block diagram of a device for trigger-based pre-emptive overhead message reading in accordance with various aspects of the present disclosure;

FIG. 6 shows a block diagram of a device for trigger-based pre-emptive overhead message reading in accordance with various aspects of the present disclosure;

FIG. 7 shows a block diagram of a device for trigger-based pre-emptive overhead message reading in accordance with various aspects of the present disclosure;

FIG. 8 illustrates a block diagram of a system for trigger-based pre-emptive overhead message reading in accordance with various aspects of the present disclosure;

FIG. 9 shows a flowchart illustrating a method for trigger-based pre-emptive overhead message reading in accordance with various aspects of the present disclosure;

FIG. 10 shows a flowchart illustrating a method for trigger-based pre-emptive overhead message reading in accordance with various aspects of the present disclosure;

FIG. 11 shows a flowchart illustrating a method for trigger-based pre-emptive overhead message reading in accordance with various aspects of the present disclosure;

FIG. 12 shows a flowchart illustrating a method for trigger-based pre-emptive overhead message reading in accordance with various aspects of the present disclosure; and

FIG. 13 shows a flowchart illustrating a method for trigger-based pre-emptive overhead message reading in accordance with various aspects of the present disclosure.

### DETAILED DESCRIPTION

A user equipment (UE) may monitor channel conditions for a serving cell and non-serving neighboring cells. The UE may determine to read the system information of a non-serving neighbor when certain channel conditions exist, or when certain performance metrics are unsatisfied. The UE may then read the system information of the non-serving neighbor cell while still connected to the serving cell (e.g., prior to handover). In some cases, the UE may store the system information in a database. Then if and when the UE attempts to access a neighbor cell (e.g., if the link to the serving cell fails) the UE may use the stored system information, and proceed with access procedures without delay.

Thus, in cases when a UE experiences a radio link failure (RLF) or handover, the UE may establish a new connection without attempting to read the system information of the neighboring (e.g., target) cell. This may reduce the delay in a connection reestablishment and/or mobility procedure, and it may mitigate the service disruption for the user. The reduction may be particularly significant in dense networks such as networks located in urban environments where cells are closely packed and channel interference is high.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

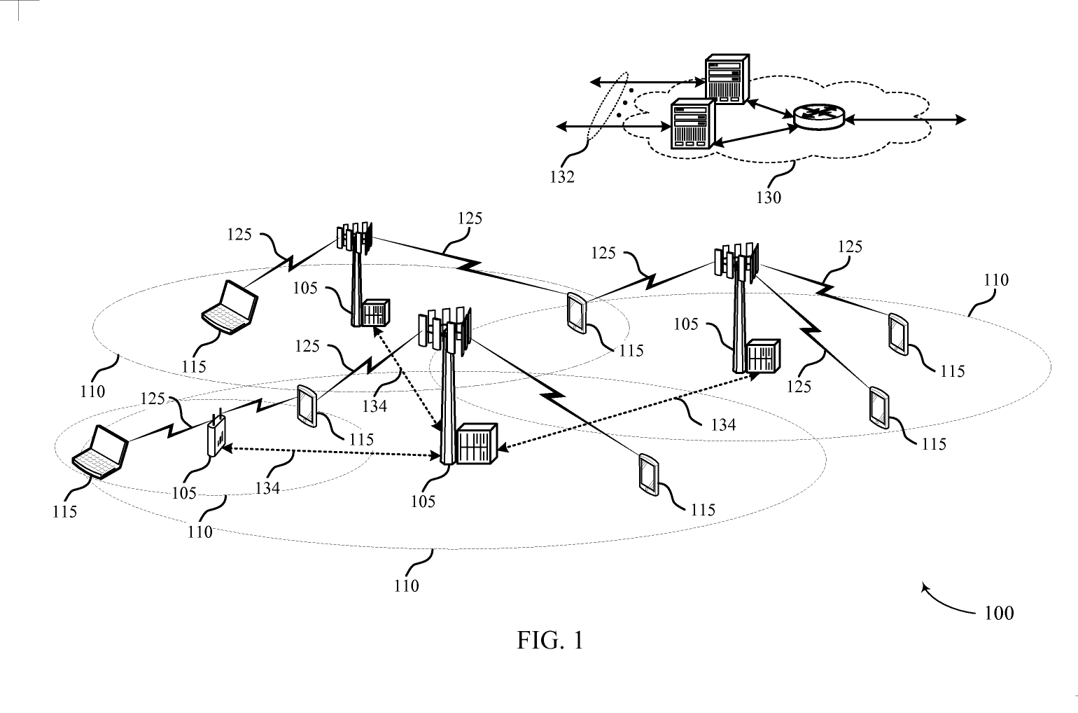

FIG. 1 illustrates an example of a wireless communications system 100 in accordance with various aspects of the present disclosure. The system 100 includes base stations 105, user equipments (UEs) 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up a portion of the coverage area (not shown). The wireless communications system 100 may include base stations 105 of different types (e.g., macro and/or small cell base stations). There may be overlapping geographic coverage areas 110 for different technologies

In some examples, the wireless communications system 100 is a Long Term Evolution (LTE)/LTE-Advanced (LTE-A) network. In LTE/LTE-A networks, the term evolved node B (eNB) may be generally used to describe the base stations 105. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs 115 with service subscriptions with the network provider. A femto cell also may cover a relatively small geographic area (e.g., a home) and may provide restricted access by UEs 115 having an association with the femto cell (e.g., UEs 115 in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or packet data convergence protocol (PDCP) layer may be IP-based. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARM) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

In some cases, a network may include small cells with coverage areas 110 that overlap the coverage area 110 of one or more macro base stations 105. For example, small cells may be added in areas with high user demand or in areas not sufficiently covered by a macro base station 105. For example, a small cell may be located in a shopping center, or in an area where signal transmissions are blocked by terrain or buildings. In some cases, the small cells may be leveraged to improve network performance by allowing macro base stations 105 to offload traffic when load is high. A network that includes both large and small cells may be known as a heterogeneous network. A heterogeneous network may also include Home eNBs (HeNBs), which may provide service to a restricted group known as a CSG. For example, an office building may contain small cells for use by the occupants of the building. In some cases, heterogeneous networks may involve more complex network planning and interference mitigation techniques than homogenous networks.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, and the like. In some examples, a UE 115 may be configured to maintain a connection with one base station 105 while receiving signaling from another base station 105.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources).

In some embodiments of the system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple input multiple output (MIMO) techniques that may take advantage of multi-path environments to transmit multiple spatial layers carrying the same or different coded data. In some examples, UEs 115 may utilize multiple antennas to simultaneous receive system inform from one base station 105 (e.g., a non-serving neighbor cell) while connected to another base station 105 (e.g., a serving cell).

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

A UE 115 attempting to access a wireless network may perform an initial cell search by detecting a primary synchronization signal (PSS) from a base station 105. The PSS may enable synchronization of slot timing and may indicate a physical layer identity value. The UE 115 may then receive a secondary synchronization signal (SSS). The SSS may enable radio frame synchronization, and may provide a cell identity value, which may be combined with the physical layer identity value to identify the cell. The SSS may also enable detection of a duplexing mode and a cyclic prefix length. Both the PSS and the SSS may be located in the central 6 resource block (RBs) (72 subcarriers) of a carrier.

After receiving the PSS and SSS, the UE 115 may receive a master information block (MIB), which may be transmitted in the physical broadcast channel (PBCH). The MIB may contain system bandwidth information, a system frame number (SFN), and a physical HARQ indicator channel (PHICH) configuration. After decoding the MIB, the UE 115 may receive one or more system information block (SIBs). For example, SIB1 may contain cell access parameters and scheduling information for other SIBs. Decoding SIB1 may enable the UE 115 to receive SIB2. SIB2 may contain RRC configuration information related to random access channel (RACH) procedures, paging, physical uplink control channel (PUCCH), physical uplink shared channel (PUSCH), power control, SRS, and cell barring.

After completing initial cell synchronization, a UE 115 may decode the MIB, SIB1 and SIB2 prior to accessing the network. The MIB carries information for UE 115 initial access, including: DL channel bandwidth in term of RBs, PHICH configuration (duration and resource assignment), and SFN.

After receiving the MIB, a UE may receive one or more SIBs. Different SIBs may be defined according to the type of system information conveyed. SIB1, for example, includes access information, including cell identity information, and it may indicate whether a UE is allowed to camp on a cell of a base station 105. SIB1 also includes cell selection information (or cell selection parameters). Additionally, SIB1 includes scheduling information for other SIBs. SIB2 may be scheduled dynamically according to information in SIB1, and includes access information and parameters related to common and shared channels. The periodicity of SIB2 can be set to 8, 16, 32, 64, 128, 256 or 512 radio frames.

After the UE 115 decodes SIB2, it may transmit a RACH preamble to a base station 105. The base station 105 may respond with a random access response that provides an UL resource grant, a timing advance and a temporary cell radio network temporary identity (C-RNTI). The UE 115 may then transmit an RRC connection request along with a transparent mode (TMs), if, for example, the UE 115 has previously been connected to the same wireless network, or a random identifier. The RRC connection request may also indicate the reason the UE 115 is connecting to the network (e.g., emergency, signaling, data exchange, etc.). The base station 105 may respond to the connection request with a contention resolution message addressed to the UE 115, which may provide a new C-RNTI. If the UE 115 receives a contention resolution message with the correct identification, it may proceed with RRC setup. If the UE 115 does not receive a contention resolution message (e.g., if there is a conflict with another UE 115) it may repeat the RACH process by transmitting a new RACH preamble.

In some cases, a UE 115 may be transferred from a serving base station 105, which may be referred to as the source base station, to another base station 105, which may be referred to as the target base station. For example, the UE 115 may be moving into the coverage area of the target base station 105, or the target base station 105 may be capable of providing better service for the UE 115; or, in some cases, the target base station 105 may be identified by the network to relieve the source base station 105 of excess load.

The transition of a UE 115 from one base station 105 to another while the UE 115 is in a connected state may be referred to as a “handover.” Prior to a handover, the source base station 105 may configure the UE 115 with procedures for measuring the signal quality of neighboring base stations 105. The UE 115 may then respond with a measurement report. The source base station 105 may use the measurement report to make the handover decision. The decision may also be based on radio resource management (RRM) factors, such as network load and interference mitigation. When the handover decision is made, the source base station 105 may send a handover request message to the target base station 105, which may include context information to prepare the target base station 105 to serve the UE 115. The target base station 105 may make an admission control decision, for example, to ensure that it can meet the quality of service (QoS) standards of the UE 115. The target base station 105 may then configure resources for the incoming UE 115, and send a handover request acknowledge message to the source base station 105, which may include RRC information to be passed on to the UE 115. The source base station 105 may then direct the UE 115 to perform the handover, and it may pass a status transfer message to the target base station 105 with PDCP bearer status information. The UE 115 may attach to the target base station 105 via a RACH procedure.

In some cases, a UE 115 may determine that a radio link has failed and initiate a radio link failure (RLF) procedure. For example, an RLF procedure may be triggered upon an RLC indication that a maximum number of retransmissions has been reached, upon receiving a maximum number of out-of-sync indications, or upon radio failure during a RACH procedure. In some cases (e.g., after reaching the limit for out-of-sync indications) a UE 115 may initiate a timer and wait to determine whether a threshold number of in-sync indications are received. If the number of in-sync indications exceeds the threshold prior to expiration of the timer, the UE 115 may abort the RLF procedure. Otherwise, the UE 115 may perform a RACH procedure to regain access to network. The RACH procedure may include transmitting an RRC connection re-establishment request including the C-RNTI, the cell identification (ID), security verification information, and a cause for re-establishment.

The base station 105 receiving the RRC connection re-establishment request message may respond with either an RRC connection re-establishment message or an RRC connection re-establishment rejection. The RRC connection re-establishment message may contain parameters for establishing a signaling radio bearer (SRB) for the UE 115 as well as information for generating a security key. Once the UE 115 receives the RRC connection establishment message it may implement the new SRB configuration and transmit an RRC connection re-establishment complete message to the base station 105.

According to the present disclosure, UE 115 may establish a connection to a serving cell of a base station 105 and monitor channel conditions for the serving cell and neighboring cells. The UE 115 may also identify performance metrics associated with the serving cell and neighboring cells. Based on the channel conditions and/or the performance metrics, the UE 115 may determine to read the system information of a non-serving neighbor while still connected to the serving cell. That is, the UE 115 may read the system information before a handover is initiated (e.g., prior to access procedures). In some examples, the UE 115 may identify neighbor cells from which to monitor system information by identifying the neighbor cells with the strongest signals over some time period (e.g., 500 ms). In some cases, if the UE 115 has transmitted a measurement report message within a certain time period, the UE 115 may use the cell ID and the evolved absolute radio frequency channel number (EARFCN) included in the MRM to identify neighbor cells for which system information should be read. The UE 115 may then read the system information, which may include information from the MIB and/or SIBs, of the non-serving neighbor cell while still connected to the serving cell. In some cases, the UE 115 may store the system information in a database. When the time comes for the UE 115 to access the neighbor cell (e.g., if the link to the serving cell fails) the UE 115 may proceed with access procedures without delay using the stored system information.

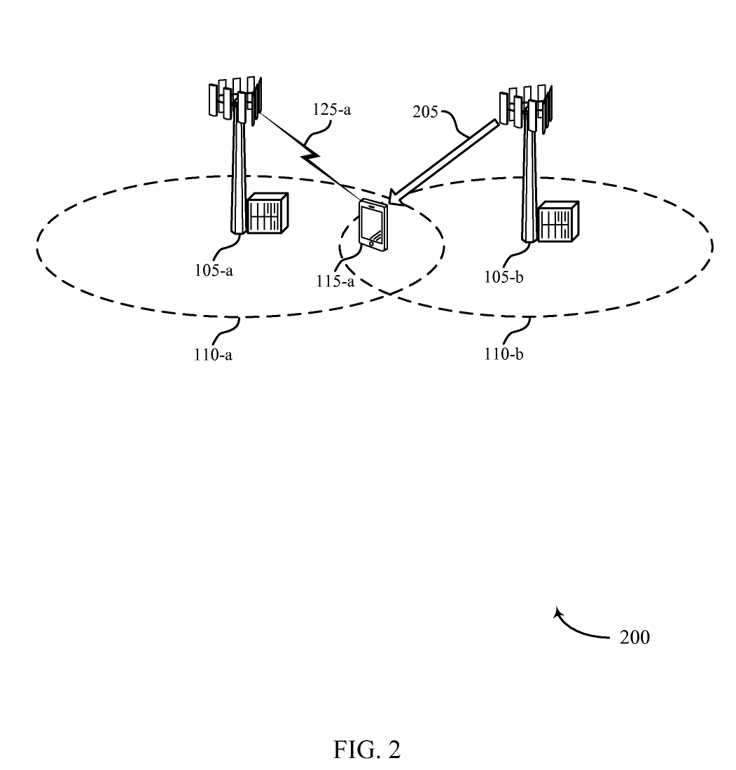

FIG. 2 illustrates an example of a wireless communications subsystem 200 for trigger-based pre-emptive overhead message reading in accordance with various aspects of the present disclosure. Wireless communications subsystem 200 may include UE 115-a, which may be an example of a UE 115 described above with reference to FIG. 1. Wireless communications subsystem 200 may also include serving base station 105-a and neighbor base station 105-b, which may be examples of a base station 105 described above with reference to FIG. 1. The base stations 105-a and 105-b may provide for wireless communications over coverage areas 110-a and 110-b, respectively.

UE 115-a may be connected to base station 105-a via communication link 125-a. But based on the channel conditions or performance metrics, UE 115-a may determine to read the system information of a non-serving cell of neighbor base station 105-b. For example, the signal quality of communication link 125-a may fall below a threshold and/or the signal quality from neighbor base station 105-b may be above a threshold. UE 115-a may then read the system information 205 of the non-serving cell of neighbor base station 105 while still connected to the serving base station 105-a via communication link 125-a. In some cases, the UE may store the system information in a database. When the time comes for the UE to access the neighbor base station 105-b (e.g., if communication link 125-a fails) UE 115-a may proceed with the access procedures without delay using the stored system information.

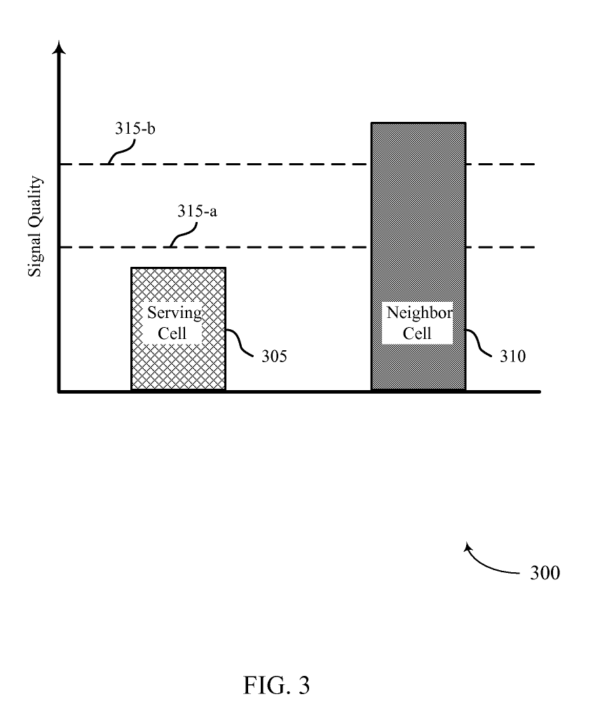

FIG. 3 illustrates an example of a channel condition diagram 300 for trigger-based pre-emptive overhead message reading in accordance with various aspects of the present disclosure. Channel condition diagram 300 illustrates one example of channel conditions that may trigger a pre-emptive reading of the system information of a neighbor cell. Channel condition diagram 300 may include a serving cell signal quality parameter 305 and a neighbor cell signal quality parameter 310. As illustrated, serving cell signal quality parameter 305 (e.g., a reference signal received quality (RSRQ) or reference signal received power (RSRP) of the serving cell) may be below a first signal quality threshold 315-a and neighbor cell signal quality parameter 310 may be above a second signal quality threshold 315-b. As another example, a pre-emptive reading of system information may be triggered when serving cell signal quality parameter 305 is greater than neighbor cell signal quality parameter 310 by a predetermined offset (not shown).

In some cases, the trigger condition for pre-emptively reading system information may correspond to the trigger condition for sending a measurement report to a base station 105. The base station 105 may provide the UE 115 with a measurement reporting configuration as part of an RRC configuration. The measurement reporting configuration may include parameters related to which neighbor cells and frequencies the UE 115 should measure, criteria for sending measurement reports, intervals for transmission of measurement reports (e.g., measurement gaps), and other related information. In some cases, measurement reports may be triggered by events related to the channel conditions of the serving cells and/or the neighbor cells.

For example, in an LTE system a first report (A1) may be triggered when the serving cell becomes better than a threshold; a second report (A2) when the serving cell becomes worse than a threshold; a third report (A3) when a neighbor cell becomes better than the primary serving cell by an offset value; a fourth report (A4) when a neighbor cell becomes better than a threshold; a fifth report (A5) when the primary serving cell becomes worse than a threshold and a neighbor cell is simultaneously better than another (e.g., higher) threshold; a sixth report (A6) when a neighbor cell becomes better than a secondary serving cell by an offset value; a seventh report (B1) when a neighbor using a different radio access technology (RAT) becomes better than a threshold; and an eighth report (B2) when a primary serving cell becomes worse than a threshold and the inter-RAT neighbor becomes better than another threshold. In some cases, the UE 115 may wait for a timer interval known as time-to-trigger (TTT) to verify that the trigger condition persists before sending the report. Other reports may be sent periodically instead of being based on a trigger condition (e.g., every two seconds a UE 115 may transmit an indication of a transport block error rate).

In this or other examples, a UE 115 may also identify and evaluate performance metrics associated with the serving cell. For example, the UE 115 may determine that an application layer packet loss value exceeds an application layer packet loss threshold, determining that a voice packet loss value exceeds a voice packet loss threshold, or determine that a block error rate (BLER) exceeds a BLER threshold. There may be one or more thresholds for evaluating a performance metric. The one or more thresholds for evaluating the performance metric, or the channel condition, may be based on, for example, a radio frequency (RF) metric, an application performance metric, an event metric, or a predetermined value. In some examples the channel condition is based, to some degree, on a measurement gap or CDRX (connected mode discontinuous reception) off period. For example, a UE 115 may wait for a measurement gap or CDRX off period to receive the system information of a neighbor cell. Pre-emptive reading of the system information may also depend on whether the UE 115 has UL data to transmit. For example, reading the system information may be delayed until the UE 115 does not have UL data for transmission if, for instance, the UE 115 does not have a scheduling request mask (SR-mask) enable.

In some examples the channel condition is based at least in part on a motion detection value. For example, a UE 115 may include a global positing system (GPS) or accelerometer device that may indicate when the UE 115 is in motion. A UE 115 may use the motion information to modify the channel condition thresholds. For example, if a UE is moving toward a neighbor cell it may lower second signal quality threshold 315-b. In some examples the channel condition is based at least in part on a QoS threshold. For example, a QoS threshold may indicate that a UE 115 is being used for VoLTE communications and may be more sensitive to service disruption. A UE 115 with a QoS threshold may therefore be more aggressive in pre-emptively reading system information.

Thus, a UE 115 may establish a connection to a serving cell and monitor serving cell signal quality parameter 305 and a neighbor cell signal quality parameter 310. Based on serving cell signal quality parameter 305 being below first signal quality threshold 315-a and neighbor cell signal quality parameter 310 being above second signal quality threshold 315-b, the UE 115 may determine to read the system information of the non-serving neighbor cell. The UE 115 may then read the system information of the non-serving neighbor cell while still connected to the serving cell. For instance, the UE 115 may utilize a secondary antenna to acquire PSS, SSS, a MIB, and/or SIBs of a non-serving neighbor cell. Then the UE 115 may proceed to access without delay by using the stored system information.

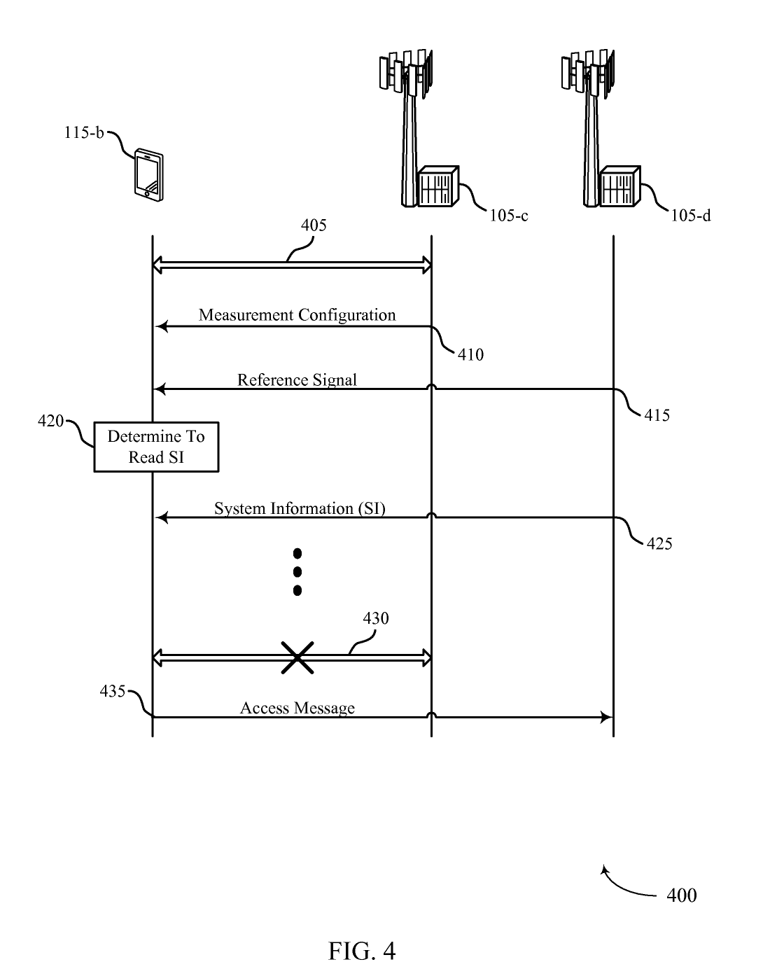

FIG. 4 illustrates an example of a signal flow diagram 400 for trigger-based pre-emptive overhead message reading in accordance with various aspects of the present disclosure. Signal flow diagram 400 may include a UE 115-b, which may be an example of a UE 115 described above with reference to FIGS. 1-2. Signal flow diagram 400 may also include serving base station 105-c and neighbor base station 105-d, which may be examples of a base station 105 described above with reference to FIGS. 1-2. Signal flow diagram 400 may also incorporate channel condition aspects described above with reference to FIG. 3.

At step 405, UE 115-b may establish (and communicate via) a connection to a serving cell (e.g., on serving base station 105-c). At step 410, serving base station may send a measurement reporting configuration to UE 115-b including instructions to monitor a cell of neighbor base station 105-d. Then, at step 415, UE 115-b may measure the signal quality of neighbor base station 105-d by receiving and analyzing a reference signal.

At step 420, UE 115-b may determine to read system information of the non-serving neighbor cell based on a channel condition or a performance metric. For example, the determination may be based on the factors described above with reference to FIG. 3.

Based on the determination, at step 425, UE 115-b may read the system information of the non-serving neighbor cell while connected to the serving cell. The system information may include a MIB, one or more SIBs, or both a MIB and SIBs. In some examples, UE 115-b receives the system information over a secondary antenna (e.g., while communicating with base station 105-c using a primary antenna). In some cases, UE 115-b may select the non-serving neighbor cell (for reading system information) based on a received signal quality of the non-serving neighbor cell.

UE 115-b may store the system information in a database for a set of neighbor cells. The database may include frequency information, public land mobile network (PLMN) information, cell IDs, information from MIBs (such as system frame numbers (SFNs) or SFN offsets), information from SIBs, channel conditions, performance metrics, signal quality information, measurement report information, and/or accessibility information. In some cases, UE 115-b may prioritize the set of neighbor cells based on the information in the database. For example, UE 115-b may prioritize the set of neighbor cells based on the channel condition comparison conditions described above with reference to FIG. 3. UE 115-b may also maintain the database and/or select an access target based on channel conditions of the neighbor cells in a rolling interval of a predetermined length. UE 115-b may associate some entries in the database with time limits, and use the time limits to determine whether the information is current. If the information is not current, UE 115-b may attempt to reread the system information. That is, in some examples, a timer or timers associated with the various system information may expire, some of the system information may be deemed to be stale, and UE 115-b may attempt to reread the current system information.

At some point, represented by step 430, UE 115-b may experience failing radio conditions and may initiate an RLF procedure on the serving cell based on such conditions. In another example, UE 115-b may receive a handover command indicating a cell on neighbor base station 105-d as the target.

Then, at step 435 UE 115-b may establish a connection to the non-serving neighbor cell based on the system information (and subsequent to the RLF procedure or handover). Based on the cached system information, UE 115-b may establish the connection with a reduced delay because it may not wait to decode new system information for the target. For example, UE 115-b may initiate an access procedure for the non-serving neighbor cell and use a stored SFN to determine which resources to use for random access preamble or for a subsequent message (e.g., for a channel quality indication (CQI) message, a connected mode discontinuous reception (CDRX) related message, a scheduling request (SR), or a sounding reference signal (SRS)).

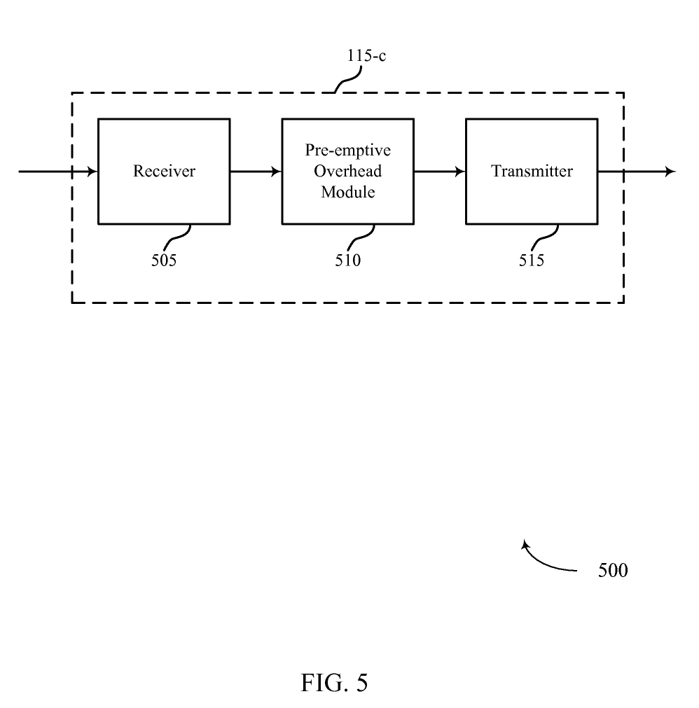

FIG. 5 shows a block diagram 500 of a UE 115-c for trigger-based pre-emptive overhead message reading in accordance with various aspects of the present disclosure. The UE 115-c may be an example of aspects of a UE 115 described with reference to FIGS. 1-4. The UE 115-c may include a receiver 505, a pre-emptive overhead module 510, and/or a transmitter 515. The UE 115-c may also include a processor. Each of these components may be in communication with one another.

The components of the UE 115-c may, individually or collectively, be implemented with at least one application specific integrated circuit (ASIC) adapted to perform some or all of the applicable functions in hardware. Alternatively, the functions may be performed by one or more other processing units (or cores), on an IC or ICs. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 505 may receive information such as packets, user data, and/or control information associated with various information channels (e.g., control channels, data channels, and information related to trigger-based pre-emptive overhead message reading, etc.). Information may be passed on to the pre-emptive overhead module 510, and to other components of the UE 115-c.

The pre-emptive overhead module 510 may establish a connection to a serving cell, determine to read system information of a non-serving neighbor cell based at least in part on a channel condition or a performance metric, and read the system information of the non-serving neighbor cell while connected to the serving cell.

The transmitter 515 may transmit signals received from other components of the UE 115-c. In some embodiments, the transmitter 515 may be collocated with the receiver 505 in a transceiver module. The transmitter 515 may include a single antenna, or it may include a plurality of antennas.

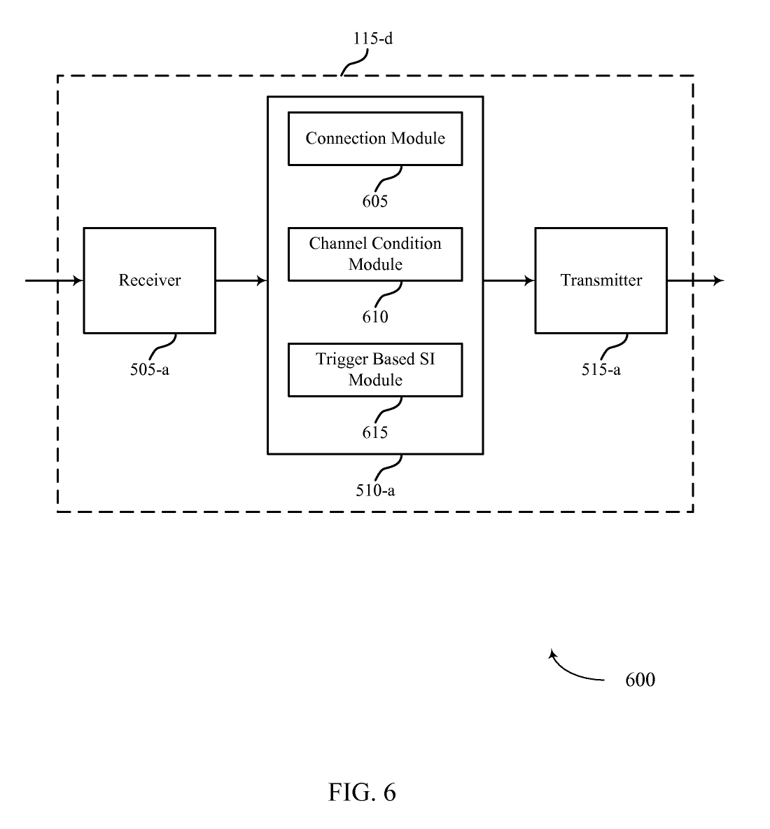

FIG. 6 shows a block diagram 600 of a UE 115-d for trigger-based pre-emptive overhead message reading in accordance with various aspects of the present disclosure. The UE 115-d may be an example of aspects of a UE 115 described with reference to FIGS. 1-5. The UE 115-d may include a receiver 505-a, a pre-emptive overhead module 510-a, and/or a transmitter 515-a. The UE 115-d may also include a processor. Each of these components may be in communication with one another. The pre-emptive overhead module 510-a may also include a connection module 605, a channel condition module 610, and a trigger-based system information (SI) module 615.

The components of the UE 115-d may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 505-a may receive information which may be passed on to the pre-emptive overhead module 510-a, and to other components of the UE 115-d. The pre-emptive overhead module 510-a may perform the operations of the pre-emptive overhead module 510 described above with reference to FIG. 5. The transmitter 515-a may transmit signals received from other components of the UE 115-d.

The connection module 605 may establish a connection to a serving cell, as described above with reference to FIGS. 2-4.

The channel condition module 610 may determine to read system information of a non-serving neighbor cell based at least in part on a channel condition or a performance metric as described above with reference to FIGS. 2-4. In some examples, identifying the channel condition includes determining that an RSRP of the serving cell may be below an RSRP threshold, determining that an RSRQ of the serving cell may be below an RSRQ threshold, determining that a difference between the RSRQ of the serving cell and an RSRQ of the non-serving neighbor cell exceeds a difference threshold, or determining that an application layer packet loss value exceeds an application layer packet loss threshold. In some examples, determining the performance metric includes determining that a voice packet loss value exceeds a voice packet loss threshold, or determining that a BLER exceeds a BLER threshold. In some examples, the channel condition may be based at least in part on a measurement gap. Additionally or alternatively, the channel condition may be based at least in part on a motion detection value. In some examples, the channel condition may be based at least in part on a QoS threshold.

The trigger-based SI module 615 may read the system information of the non-serving neighbor cell while connected to the serving cell, as described above with reference to FIGS. 2-4. The trigger-based SI module 615 may also reread the system information, based on the determination that the at least one entry is not current, while connected to the serving cell, as described above with reference to FIGS. 2-4. In some examples, reading the system information comprises receiving the system information over a secondary antenna. The system information may include a MIB or a SIB, or both.

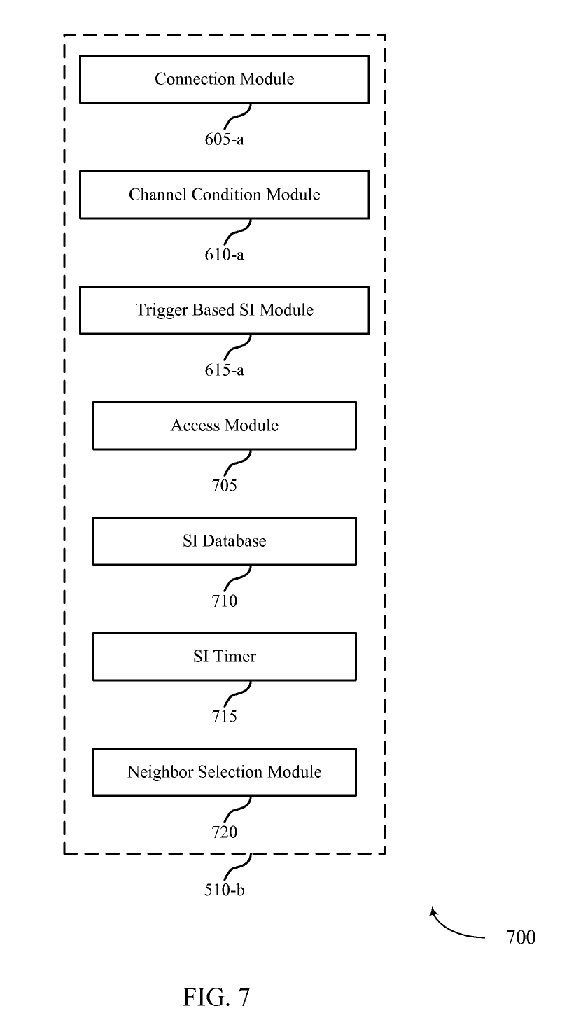

FIG. 7 shows a block diagram 700 of a pre-emptive overhead module 510-b for trigger-based pre-emptive overhead message reading in accordance with various aspects of the present disclosure. The pre-emptive overhead module 510-b may be an example of aspects of a pre-emptive overhead module 510 described with reference to FIGS. 5-6. The pre-emptive overhead module 510-b may include a connection module 605-a, a channel condition module 610-a, and a trigger-based SI module 615-a. Each of these modules may perform the functions described above with reference to FIG. 6. The pre-emptive overhead module 510-b may also include an access module 705, an SI database 710, an SI timer 715, and a neighbor selection module 720. Each of these modules may be in communication with one another.

The components of the pre-emptive overhead module 510-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The access module 705 may initiate an access procedure for the non-serving neighbor cell based on, wholly or partially, the system information, as described above with reference to FIGS. 2-4. The access module 705 may also establish a connection to the non-serving neighbor cell based on the system information and the RLF procedure, as described above with reference to FIGS. 2-4.

The SI database 710 may store the system information in a database for a set of neighbor cells, as described above with reference to FIGS. 2-4. In some examples, the database includes frequency information, a PLMN, a cell ID, information from a MIB, information from a SIB, signal quality information, measurement report information, or accessibility information. The SI database 710 may also prioritize the set of neighbor cells based at least in part on the database, as described above with reference to FIGS. 2-4.

The SI timer 715 may associate entries in the database with a time limit, and the entries may be based on the system information as described above with reference to FIGS. 2-4. The SI timer 715 may also determine that an entry is not current based on the time limit, as described above with reference to FIGS. 2-4.

The neighbor selection module 720 may select the non-serving neighbor cell based on a received signal quality of the non-serving neighbor cell; reading the system information may, for instance, be based on the selection as described above with reference to FIGS. 2-4.

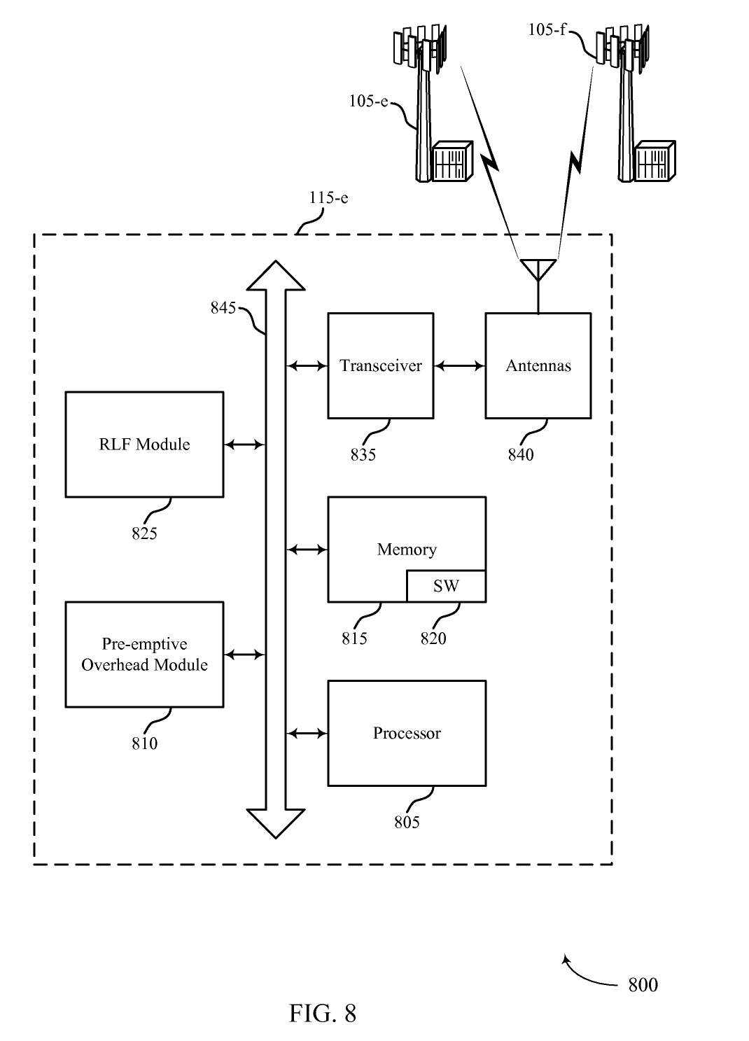

FIG. 8 shows a diagram of a system 800 for trigger-based pre-emptive overhead message reading in accordance with various aspects of the present disclosure. System 800 may include a UE 115-e, which may be an example of an UE 115 described above with reference to FIGS. 1-7. The UE 115-e may include a pre-emptive overhead module 810, which may be an example of a pre-emptive overhead module 510 described with reference to FIGS. 2-7. The UE 115-e may also include an RLF module 825. The UE 115-e may also include components for bi-directional voice and data communications, including components for transmitting communications and components for receiving communications. For example, the UE 115-e may communicate bi-directionally with base station 105-e and/or a base station 105-f.

The RLF module 825 may initiate an RLF procedure on the serving cell based on the channel condition or a performance metric as described above with reference to FIGS. 1-4. For example, an RLF procedure may be triggered upon an RLC indication that a maximum number of retransmissions has been reached, upon receiving a maximum number of out-of-sync indications, or upon radio failure during a RACH procedure. In some cases (e.g., after reaching the limit for out-of-sync indications) UE 115-e may initiate a timer and wait to determine whether a threshold number of in-sync indications are received. If the number of in-sync indications exceeds the threshold prior to expiration of the timer, UE 115-e may abort the RLF procedure. Otherwise, UE 115-e may perform a RACH procedure to regain access to network. The RACH procedure may include transmitting an RRC connection re-establishment request including the C-RNTI, the cell ID, security verification information, and a cause for re-establishment. The base station 105 receiving the request may respond with either an RRC connection re-establishment message or an RRC connection re-establishment rejection.

The UE 115-e may also include a processor module 805, and memory 815 (including software (SW) 820), a transceiver module 835, and one or more antenna(s) 840, which each may communicate, directly or indirectly, with one another (e.g., via buses 845). The transceiver module 835 may communicate bi-directionally, via the antenna(s) 840 and/or wired or wireless links, with one or more networks, as described above. For example, the transceiver module 835 may communicate bi-directionally with a base station 105 and/or another UE 115. The transceiver module 835 may include a modem to modulate the packets and provide the modulated packets to the antenna(s) 840 for transmission, and to demodulate packets received from the antenna(s) 840. While the UE 115-e may include a single antenna 840, the UE 115-e may also have multiple antennas 840 capable of concurrently transmitting and/or receiving multiple wireless transmissions.

The memory 815 may include random access memory (RAM) and read only memory (ROM). The memory 815 may store computer-readable, computer-executable software/firmware code 820 including instructions that, when executed, cause the processor module 805 to perform various functions described herein (e.g., trigger-based pre-emptive overhead message reading, etc.). Alternatively, the software/firmware code 820 may not be directly executable by the processor module 805 but cause a computer (e.g., when compiled and executed) to perform functions described herein. The processor module 805 may include an intelligent hardware device, e.g., a central processing unit (CPU), a microcontroller, an ASIC, etc.

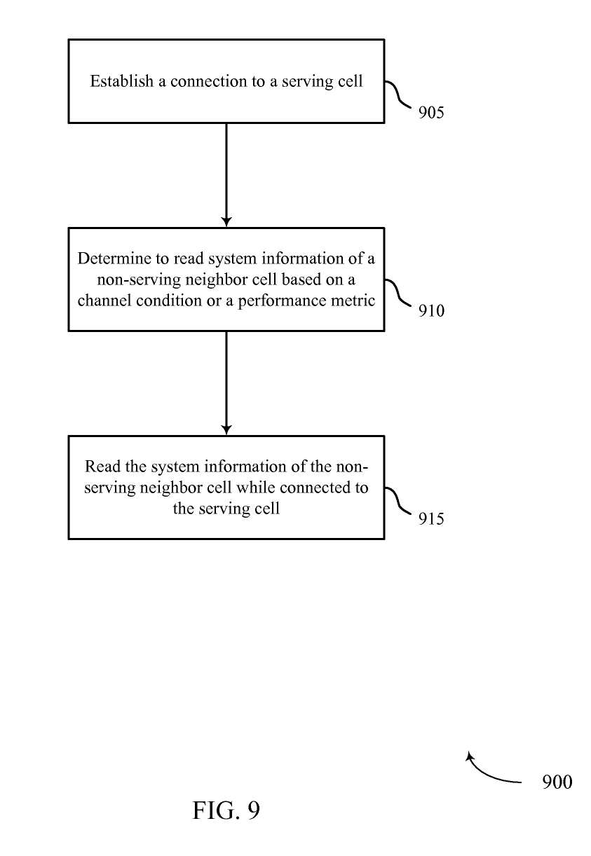

FIG. 9 shows a flowchart illustrating a method 900 for trigger-based pre-emptive overhead message reading in accordance with various aspects of the present disclosure. The operations of method 900 may be implemented by a UE 115 or its components as described with reference to FIGS. 1-8. For example, the operations of method 900 may be performed by the pre-emptive overhead module 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware.

At block 905, the UE 115 may establish a connection to a serving cell, as described above with reference to FIGS. 2-4. In certain examples, the operations of block 905 may be performed by the connection module 605, as described above with reference to FIG. 6.

At block 910, the UE 115 may determine to read system information of a non-serving neighbor cell based at least in part on a channel condition or a performance metric, as described above with reference to FIGS. 2-4. In certain examples, the operations of block 910 may be performed by the channel condition module 610, as described above with reference to FIG. 6.

At block 915, the UE 115 may read the system information of the non-serving neighbor cell while connected to the serving cell, as described above with reference to FIGS. 2-4. In certain examples, the operations of block 915 may be performed by the trigger-based SI module 615, as described above with reference to FIG. 6.

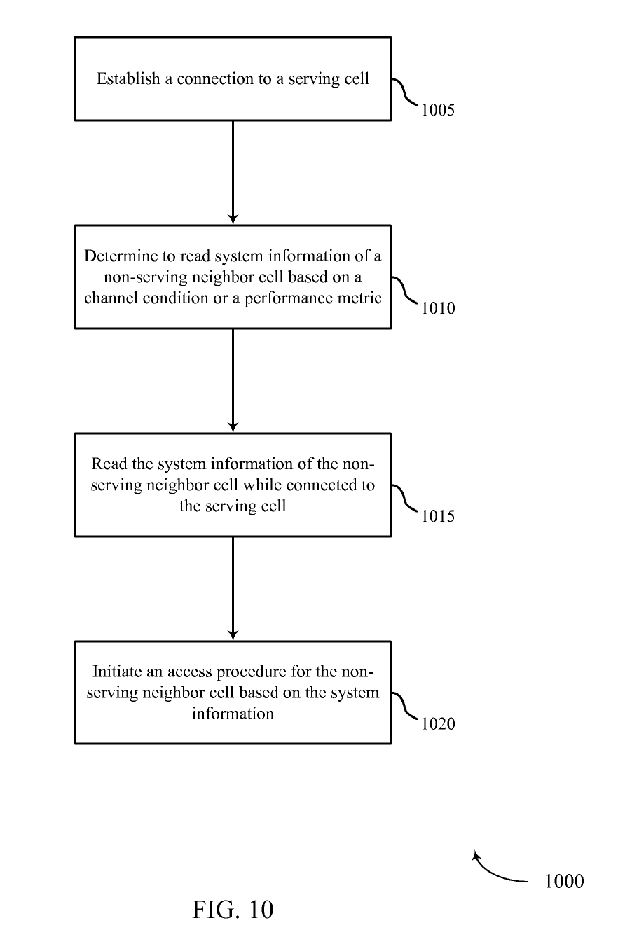

FIG. 10 shows a flowchart illustrating a method 1000 for trigger-based pre-emptive overhead message reading in accordance with various aspects of the present disclosure. The operations of method 1000 may be implemented by a UE 115 or its components as described with reference to FIGS. 1-8. For example, the operations of method 1000 may be performed by the pre-emptive overhead module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1000 may also incorporate aspects of method 900 of FIG. 9.

At block 1005, the UE 115 may establish a connection to a serving cell, as described above with reference to FIGS. 2-4. In certain examples, the operations of block 1005 may be performed by the connection module 605, as described above with reference to FIG. 6.

At block 1010, the UE 115 may determine to read system information of a non-serving neighbor cell based at least in part on a channel condition or a performance metric, as described above with reference to FIGS. 2-4. In certain examples, the operations of block 1010 may be performed by the channel condition module 610, as described above with reference to FIG. 6.

At block 1015, the UE 115 may read the system information of the non-serving neighbor cell while connected to the serving cell, as described above with reference to FIGS. 2-4. In certain examples, the operations of block 1015 may be performed by the trigger-based SI module 615, as described above with reference to FIG. 6.

At block 1020, the UE 115 may initiate an access procedure for the non-serving neighbor cell based at least in part on the system information, as described above with reference to FIGS. 2-4. In certain examples, the operations of block 1020 may be performed by the access module 705, as described above with reference to FIG. 7.

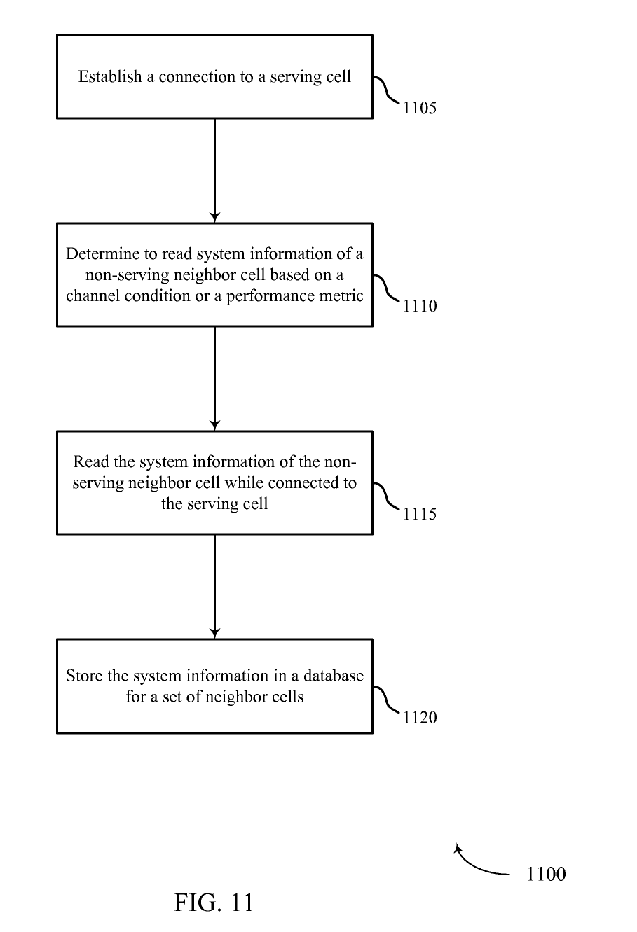

FIG. 11 shows a flowchart illustrating a method 1100 for trigger-based pre-emptive overhead message reading in accordance with various aspects of the present disclosure. The operations of method 1100 may be implemented by a UE 115 or its components, as described with reference to FIGS. 1-8. For example, the operations of method 1100 may be performed by the pre-emptive overhead module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1100 may also incorporate aspects of methods 900, and 1000 of FIGS. 9 and 10.

At block 1105, the UE 115 may establish a connection to a serving cell, as described above with reference to FIGS. 2-4. In certain examples, the operations of block 1105 may be performed by the connection module 605, as described above with reference to FIG. 6.

At block 1110, the UE 115 may determine to read system information of a non-serving neighbor cell based at least in part on a channel condition or a performance metric, as described above with reference to FIGS. 2-4. In certain examples, the operations of block 1110 may be performed by the channel condition module 610, as described above with reference to FIG. 6.

At block 1115, the UE 115 may read the system information of the non-serving neighbor cell while connected to the serving cell, as described above with reference to FIGS. 2-4. In certain examples, the operations of block 1115 may be performed by the trigger-based SI module 615, as described above with reference to FIG. 6.

At block 1120, the UE 115 may store the system information in a database for a set of neighbor cells, as described above with reference to FIGS. 2-4. In certain examples, the operations of block 1120 may be performed by the SI database 710, as described above with reference to FIG. 7.

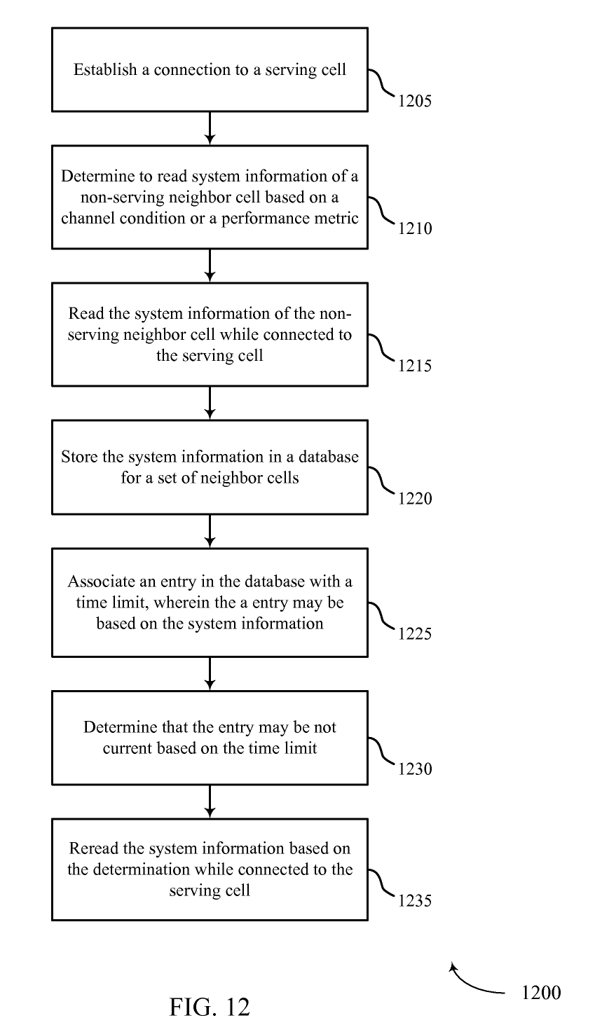

FIG. 12 shows a flowchart illustrating a method 1200 for trigger-based pre-emptive overhead message reading in accordance with various aspects of the present disclosure. The operations of method 1200 may be implemented by a UE 115 or its components, as described with reference to FIGS. 1-8. For example, the operations of method 1200 may be performed by the pre-emptive overhead module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1200 may also incorporate aspects of methods 900, 1000, and 1100 of FIGS. 9-11.

At block 1205, the UE 115 may establish a connection to a serving cell as described above with reference to FIGS. 2-4. In certain examples, the operations of block 1205 may be performed by the connection module 605, as described above with reference to FIG. 6.

At block 1210, the UE 115 may determine to read system information of a non-serving neighbor cell based at least in part on a channel condition or a performance metric, as described above with reference to FIGS. 2-4. In certain examples, the operations of block 1210 may be performed by the channel condition module 610, as described above with reference to FIG. 6.

At block 1215, the UE 115 may read the system information of the non-serving neighbor cell while connected to the serving cell, as described above with reference to FIGS. 2-4. In certain examples, the operations of block 1215 may be performed by the trigger-based SI module 615, as described above with reference to FIG. 6.

At block 1220, the UE 115 may store the system information in a database for a set of neighbor cells, as described above with reference to FIGS. 2-4. In certain examples, the operations of block 1220 may be performed by the SI database 710, as described above with reference to FIG. 7.

At block 1225, the UE 115 may associate at least one entry in the database with a time limit, wherein the at least one entry is based on the system information, as described above with reference to FIGS. 2-4. In certain examples, the operations of block 1225 may be performed by the SI timer 715, as described above with reference to FIG. 7.

At block 1230, the UE 115 may determine that the at least one entry is not current based on the time limit as described above with reference to FIGS. 2-4. In certain examples, the operations of block 1230 may be performed by the SI timer 715, as described above with reference to FIG. 7.

At block 1235, the UE 115 may reread the system information based on the determination that the at least one entry is not current while connected to the serving cell as described above with reference to FIGS. 2-4. In certain examples, the operations of block 1235 may be performed by the trigger-based SI module 615, as described above with reference to FIG. 6.

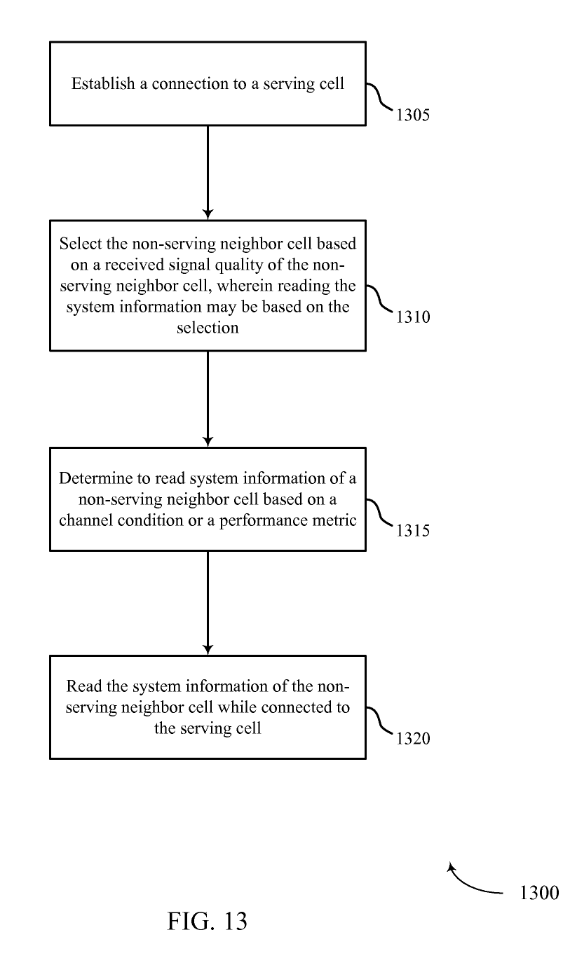

FIG. 13 shows a flowchart illustrating a method 1300 for trigger-based pre-emptive overhead message reading in accordance with various aspects of the present disclosure. The operations of method 1300 may be implemented by a UE 115 or its components as described with reference to FIGS. 1-8. For example, the operations of method 1300 may be performed by the pre-emptive overhead module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1300 may also incorporate aspects of methods 900, 1000, 1100, and 1200 of FIGS. 9-12.

At block 1305, the UE 115 may establish a connection to a serving cell, as described above with reference to FIGS. 2-4. In certain examples, the operations of block 1305 may be performed by the connection module 605, as described above with reference to FIG. 6.

At block 1310, the UE 115 may select the non-serving neighbor cell based on a received signal quality of the non-serving neighbor cell, wherein reading the system information is based on the selection as described above with reference to FIGS. 2-4. In certain examples, the operations of block 1310 may be performed by the neighbor selection module 720, as described above with reference to FIG. 7.

At block 1315, the UE 115 may determine to read system information of a non-serving neighbor cell based at least in part on a channel condition or a performance metric, as described above with reference to FIGS. 2-4. In certain examples, the operations of block 1315 may be performed by the channel condition module 610, as described above with reference to FIG. 6.

At block 1320, the UE 115 may read the system information of the non-serving neighbor cell while connected to the serving cell as described above with reference to FIGS. 2-4. In certain examples, the operations of block 1320 may be performed by the trigger-based SI module 615, as described above with reference to FIG. 6.

Thus, methods 900, 1000, 1100, 1200, and 1300 may provide for trigger-based pre-emptive overhead message reading. It should be noted that methods 900, 1000, 1100, 1200, and 1300 describe possible implementation, and that the operations and the steps may be rearranged or otherwise modified such that other implementations are possible. In some examples, aspects from two or more of the methods 900, 1000, 1100, 1200, and 1300 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as CDMA, time division multiple access (TDMA), frequency division multiple access (FDMA), OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of UMTS that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
establishing a connection to a serving cell;
determining to read system information of a non-serving neighbor cell based at least in part on a channel condition or a performance metric; and
reading the system information of the non-serving neighbor cell while connected to the serving cell.

2. The method of claim 1, further comprising:
initiating an access procedure for the non-serving neighbor cell based at least in part on the system information.

3. The method of claim 1, further comprising:
storing the system information in a database for a set of neighbor cells.

4. The method of claim 3, wherein the database comprises frequency information, a public land mobile network (PLMN), a cell identification (ID), information from a master information block (MIB), information from a system information block (SIB), signal quality information, measurement report information, or accessibility information.

5. The method of claim 3, further comprising:
prioritizing the set of neighbor cells based at least in part on the database.

6. The method of claim 3, further comprising:
associating at least one entry in the database with a time limit, wherein the at least one entry is based on the system information;
determining that the at least one entry is not current based on the time limit; and
rereading the system information based on the determination that the at least one entry is not current while connected to the serving cell.

7. The method of claim 1, further comprising:
selecting the non-serving neighbor cell based on a received signal quality of the non-serving neighbor cell, wherein reading the system information is based on the selection.

8. The method of claim 1, further comprising:
identifying the channel condition or performance metric, wherein identifying the channel condition or performance metric comprises:
determining that a reference signal received power (RSRP) of the serving cell is below an RSRP threshold, determining that a reference signal received quality (RSRQ) of the serving cell is below an RSRQ threshold, determining that a difference between the RSRQ of the serving cell and an RSRQ of the non-serving neighbor cell exceeds a difference threshold, determining that an application layer packet loss value exceeds an application layer packet loss threshold, determining that a voice packet loss value exceeds a voice packet loss threshold, or determining that a block error rate (BLER) exceeds a BLER threshold.

9. The method of claim 8, further comprising:
initiating a radio link failure (RLF) procedure on the serving cell based on the channel condition; and
establishing a connection to the non-serving neighbor cell based on the system information and the RLF procedure.

10. The method of claim 1, wherein reading the system information comprises:
receiving the system information over a secondary antenna.

11. The method of claim 1, wherein the system information comprises a MIB, one or more SIBS, or both.

12. The method of claim 1, wherein the channel condition is based at least in part on at least one of a measurement gap, a motion detection value, or a quality of service (QoS) threshold.

13. An apparatus for wireless communication at a user equipment (UE), comprising:
a processor;
memory in electronic communication with the processor; and
instructions stored in the memory; wherein the instructions are executable by the processor to:
establish a connection to a serving cell;
determine to read system information of a non-serving neighbor cell based at least in part on a channel condition or a performance metric; and
read the system information of the non-serving neighbor cell while connected to the serving cell.

14. The apparatus of claim 13, wherein the instructions are executable by the processor to:
initiate an access procedure for the non-serving neighbor cell based at least in part on the system information.

15. The apparatus of claim 13, wherein the instructions are executable by the processor to:
store the system information in a database for a set of neighbor cells.

16. The apparatus of claim 15, wherein the database comprises frequency information, a public land mobile network (PLMN), a cell identification (ID), information from a master information block (MIB), information from a system information block (SIB), signal quality information, measurement report information, or accessibility information.

17. The apparatus of claim 15, wherein the instructions are executable by the processor to:
prioritize the set of neighbor cells based at least in part on the database.

18. The apparatus of claim 15, wherein the instructions are executable by the processor to:
associate at least one entry in the database with a time limit, wherein the at least one entry is based on the system information;
determine that the at least one entry is not current based on the time limit; and
reread the system information based on the determination that the at least one entry is not current while connected to the serving cell.

19. The apparatus of claim 13, wherein the instructions are executable by the processor to:
select the non-serving neighbor cell based on a received signal quality of the non-serving neighbor cell, wherein reading the system information is based on the selection.

20. The apparatus of claim 13, further comprising:
identifying the channel condition or performance metric, wherein identifying the channel condition or performance metric comprises:
determining that a reference signal received power (RSRP) of the serving cell is below an RSRP threshold, determining that a reference signal received quality (RSRQ) of the serving cell is below an RSRQ threshold, determining that a difference between the RSRQ of the serving cell and an RSRQ of the non-serving neighbor cell exceeds a difference threshold, determining that an application layer packet loss value exceeds an application layer packet loss threshold, determining that a voice packet loss value exceeds a voice packet loss threshold, or determining that a block error rate (BLER) exceeds a BLER threshold.

21. The apparatus of claim 20, wherein the instructions are executable by the processor to:
initiate a radio link failure (RLF) procedure on the serving cell based on the channel condition; and
establish a connection to the non-serving neighbor cell based on the system information and the RLF procedure.

22. The apparatus of claim 13, wherein reading the system information comprises:
receiving the system information over a secondary antenna.

23. The apparatus of claim 13, wherein the system information comprises a MIB, one or more SIBS, or both.

24. The apparatus of claim 13, wherein the channel condition is based at least in part on a measurement gap, a motion detection value, or a quality of service (QoS) threshold.

25. An apparatus for wireless communication at a user equipment (UE), comprising:
means for establishing a connection to a serving cell;
means for determining to read system information of a non-serving neighbor cell based at least in part on a channel condition or a performance metric; and
means for reading the system information of the non-serving neighbor cell while connected to the serving cell.

26. The apparatus of claim 25, further comprising:
means for initiating an access procedure for the non-serving neighbor cell based at least in part on the system information.

27. The apparatus of claim 25, further comprising:
means for storing the system information in a database for a set of neighbor cells.

28. The apparatus of claim 27, wherein the database comprises frequency information, a public land mobile network (PLMN), a cell identification (ID), information from a master information block (MIB), information from a system information block (SIB), signal quality information, measurement report information, or accessibility information.

29. The apparatus of claim 27, further comprising:
means for prioritizing the set of neighbor cells based at least in part on the database.

30. A non-transitory computer-readable medium storing code for wireless communication at a user equipment (UE), the code comprising instructions executable to:
establish a connection to a serving cell;
determine to read system information of a non-serving neighbor cell based at least in part on a channel condition or a performance metric; and
read the system information of the non-serving neighbor cell while connected to the serving cell.
